(19) United States
(12) Patent Application Publication
(10) Pub. No.: US 2008/0195782 A1
(43) Pub. Date: Aug. 14, 2008

(54) BUS SYSTEM AND CONTROL METHOD THEREOF

(75) Inventor: Yong-seok YI, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Gyeonggi-do (KR)

(21) Appl. No.: 11/871,305

(22) Filed: Oct. 12, 2007

(30) Foreign Application Priority Data
Feb. 9, 2007 (KR) 10-2007-0013825

(51) Int. Cl. G06F 13/368

(52) U.S. Cl. 710/110

(57) ABSTRACT

A bus system transmitting estimated standby time and a method of controlling the bus system are provided. The bus system includes a plurality of masters, a slave, and a bus unit which supports connections between the plurality of masters and the slave via a bus, and transmits an estimated standby time to at least one master among the plurality of masters if one of the plurality of masters already occupies the bus. Accordingly, the master may schedule a valid operation using the estimated standby time.

### CROSS-REFERENCE TO RELATED APPLICATIONS

This application claims the benefit of Korean Patent Application No. 10-2007-0013825 filed on Feb. 9, 2007 in the Korean Intellectual Property Office, the entire disclosure of which is incorporated herein by reference.

### BACKGROUND OF THE INVENTION

1. Field of the Invention

Methods and apparatuses consistent with the present invention relate to a bus system and a control method thereof, and more particularly, to a bus system and a control method thereof which is used in a System-on-Chip.

2. Description of the Related Art

A System-on-Chip (SoC) is a device in which a plurality of chips are integrated into a single chip. Such SoCs, in which a system is implemented as a single chip, are becoming widespread.

A system refers to a multi-purpose device designed to conduct operations to achieve a specific object, and generally may comprise a computer, a peripheral device, and software.

SoCs designed to implement a system vary according to the field of application. However, SoCs may generally consist of a processor to control the operation of the chip using software and a memory to store and use data. The SoC may also comprise a radio frequency (RF) module, analog module, an application specific integrated circuit (ASIC) module having special functions, or a peripheral device module according to a field of application of a chip. The SoCs operate while transmitting and receiving data by being interconnected so that the modules, which are independent in character or function, may acquire special system functions.

Various large modules are compositively connected in the SoC, so the scale is large, and much time and human power are required after its conception for verification and production. In order to achieve this, design methods using intellectual properties (IPs) and design methods using a platform among methods to simplify SoC development are increasing.

Platforms are broadly divided into a first type having SoC architecture, and a second type using IP interface standards. SoC architecture consists of a signal connection protocol with a semiconductor module (or IP) and a signal connection topology. The signal connection topology refers to the physical structure of buses, which includes a single shared bus structure consisting of a single bus, a hierarchical bus structure which uses a bridge to connect a plurality of buses, a ring bus structure which connects IPs in a token ring method, and a crossbar switch bus structure in which data buses are fixed to respective IPs.

This complicated system becomes more complicated by connecting verified design modules. In order that 4 IPs having 32-bit structure (32-bit addresses, 32-bit data) may be directly connected and active, (32 bit+32 bit)×3=192 bit lines may be crossed while charging whole chips. The greater IP is, the more complicated the data line becomes. One method of solving this problem is with a shared bus structure, which is used even in a modern printed circuit board (PCB) structure. The shared bus structure refers to a structure connecting IPs throughout whole chips using shared data lines. As an example of the above, if there are four IPs having a 32-bit structure, the shared bus may have (32 bit+32 bit)=64 bit lines. This shared bus has data lines with the same number of bits even if the number of IPs increases. If shared buses are used, the number of data lines is reduced, which is convenient, but shared buses cannot be connected simultaneously to data from more than one IP. Therefore, each master using a shared bus cannot perform other tasks during standby time of the bus.

FIGS. 1A and 1B are diagrams provided to explain problems in the related art.

FIG. 1A is a diagram illustrating components constituting an SoC architecture using a shared bus. Referring to FIG. 1A, a plurality of masters (Master 1 to Master n) transmit data to and receive data from a plurality of slaves (slave 1 to slave n) through an on-chip bus.

FIG. 1B is a diagram illustrating the state of a master requesting use of a bus.

In FIG. 1B, the master must remain in an idle state (IDLE TIME) after sending a request signal (reqm) for using a bus until receiving a grant signal (grantm), so is unable to perform other operations.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

The present invention provides a bus system and a control method thereof to transmit estimated standby time to a master which requests a use of a bus, and to execute valid operation during the estimated standby time.

According to an aspect of the present invention, there is provided a bus system comprising a plurality of masters; a slave; and a bus unit which supports connections between the plurality of masters and the slave, and transmits an estimated standby time to at least one master among the plurality of masters if one of the plurality of masters already occupies the bus.

The bus unit may comprise a master interface unit which communicates with the plurality of masters; and a control unit which checks the estimated standby time, and transmits the checked standby time to the at least one master through the master interface unit.

The bus unit may further comprise a memory which stores existing standby time data of the plurality of masters, wherein the control unit determines the estimated standby time considering the existing standby time.

The bus unit may further comprise a memory which stores data on the remaining time for which a master from among the plurality of masters will use a bus, and data on the time another master requests use of the bus, wherein the control unit determines the estimated standby time considering the remaining time for using a bus and the requested time for using a bus.

The bus unit may further comprise a memory which stores data on the remaining time for which a master from among the plurality of masters will use a bus, and data on the time another master requests use of the bus, wherein the control unit determines the estimated standby time considering the remaining time for using a bus and the requested time for using a bus.

The bus unit may further comprise a memory which stores the fixed estimated standby time data on the plurality of masters, wherein the control unit determines the estimated standby time considering the fixed estimated standby time.

The master may comprise a bus interface unit which transmits and receives data by interfacing with the bus unit; and a scheduler which schedules operations using the estimated standby time if the estimated standby time is transmitted through the bus interface unit.

The bus system may be an on chip bus system which is used in an SoC.

According to another aspect of the present invention, there is provided a method of controlling a bus system comprising a bus unit which supports connections between a plurality of masters and a slave, the method comprising transmitting and receiving data through the slave and the bus by a master I of the plurality of masters; requesting a use of the bus by a master II; and transmitting estimated standby time of the master II.

The method may further comprise determining the estimated standby time considering the existing standby time of the plurality of masters.

The method may further comprise determining the estimated standby time considering the remaining time for using a bus of the master II and the requested time of another master which previously requests use of a bus.

The method may further comprise determining the priority order of masters which requests use of a bus; and determining the estimated standby time considering the remaining time for using a bus of the master I and the requested time for using a bus of another master if there is another master having a higher priority than the master II.

The method may further comprise determining the estimated standby time considering the fixed estimated standby time data on the plurality of masters.

The method may further comprise scheduling operations using the estimated standby time which is received from the bus.

The bus system may be an on chip bus system which is used in an SoC.

### BRIEF DESCRIPTION OF THE DRAWINGS

The above aspects of the present invention will be more apparent by describing certain exemplary embodiments of the present invention with reference to the accompanying drawings, in which:

FIG. 1A is a diagram illustrating components constituting an SoC architecture using a shared bus according to the related art;

FIG. 1B is a diagram illustrating the state of a master requesting use of a bus according to the related art;

FIG. 2 is a block diagram illustrating a bus system according to an exemplary embodiment of the present invention;

FIG. 3 is a block diagram illustrating the detailed construction of the masters illustrated in FIG. 2 according to an exemplary embodiment of the present invention;

FIGS. 4A and 4B are block diagrams illustrating the detailed construction of the bus unit illustrated in FIG. 2 according to exemplary embodiments of the present invention;

FIG. 5 is a diagram illustrating an interface with components of an on-chip bus system according to an exemplary embodiment of the present invention;

FIGS. 6A to 6D are tables illustrating various methods determining estimated standby times of masters;

FIGS. 7A and 7B are diagrams illustrating estimated standby times of masters according to various cases;

FIG. 8 is a flowchart illustrating a method for controlling a bus system according to an exemplary embodiment of the present invention; and

FIG. 9 is a flowchart illustrating a method for controlling a bus system according to another exemplary embodiment of the present invention.

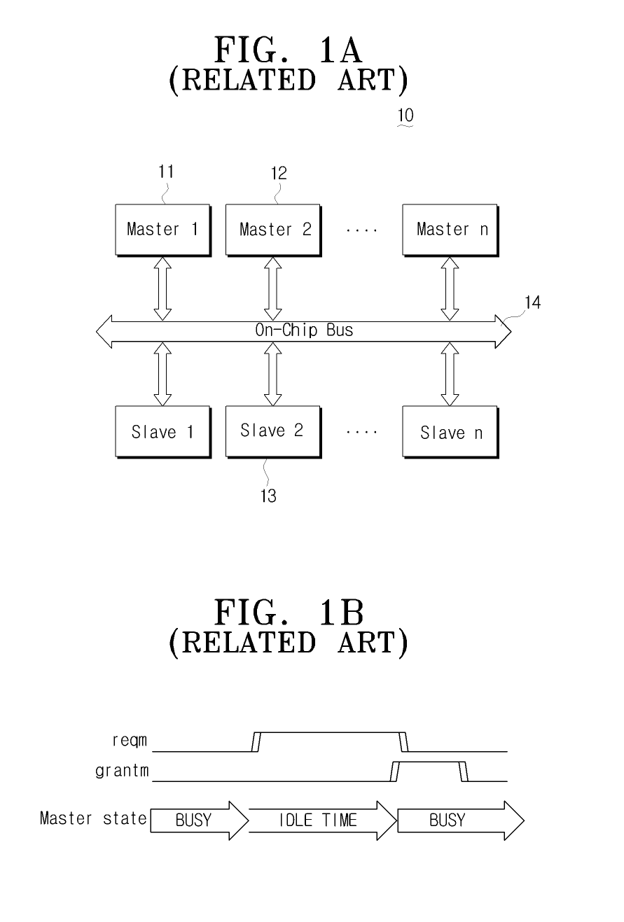

### DETAILED DESCRIPTION OF EXEMPLARY EMBODIMENTS OF THE INVENTION

Certain exemplary embodiments of the present invention will be described in greater detail with reference to the accompanying drawings.

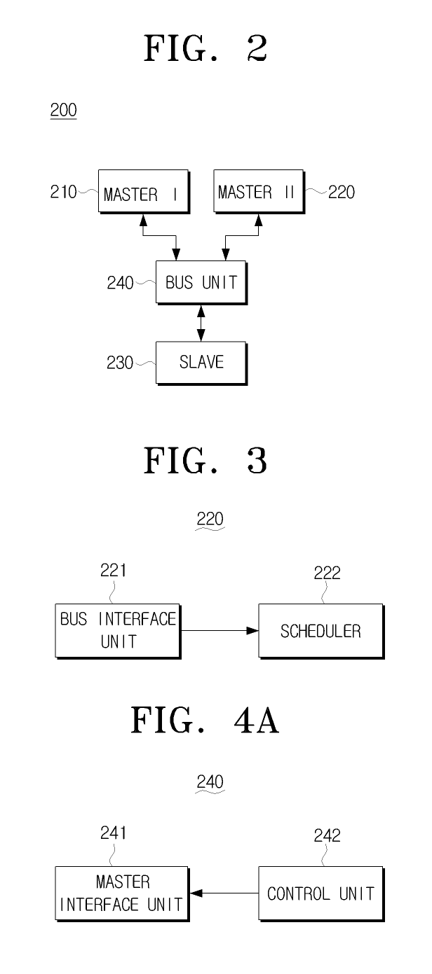

FIG. 2 is a block diagram illustrating a bus system according to an exemplary embodiment of the present invention. In FIG. 2, a bus system 200 comprises a master I 210, a master II 220, a slave 230, and a bus unit 240.

The bus system 200 may be implemented as an on-chip bus system. The on-chip bus is a protocol which is essential for SoCs.

The masters 210 and 220 refer to IPs, or other components having authorization to use a bus. The masters 210 and 220 may, for example, be implemented as a central processing unit (CPU), a hard disc drive (HDD) controller, a microprocessor, an audio digital signal processor (DSP), or a Moving Picture Experts Group (MPEG) codec, etc.

The slave 230 refers to an IP or other components controlled by the masters 210 and 220. The slave 230 may be implemented as an input/output device, or a memory. Although the above example has a bus system comprising two masters and one slave for convenient description, the number of masters and slaves may be increased as occasion demands.

The masters 210 and 220 write data to or read data from the slave 230, and to do so, request bus occupation from the bus unit 240. In an exemplary embodiment of the present invention, it is assumed that the master I 210 occupies the bus to transmit data to and receive data from the slave 230, and the master II 220 requests use of the bus.

The bus unit 240 supports connections between the masters 210 and 220 and the slave 230. Conventionally, bus occupation may be granted to only one specific master, taking into consideration whether a master which is currently using the bus exists or not, and considering the preset priority of masters. If the master I 210 already occupies the bus, the bus unit 240 transmits the estimated standby time to the master II 220 which requests bus occupation.

The master I 210 which is granted bus occupation becomes the bus master 210, and writes data to or reads data from the slave 230. The bus master I 210 occupies the bus while the data is written to or read from the slave 230. The bus unit 240 transmits the estimated standby time to the master II 220. The master II 220, which requests bus occupation, must wait until the operation of writing or reading the data is terminated by the bus master 210, and conducts different operations using the estimated standby time received from the bus unit 240 while the master II 220 waits for the master I 210.

FIG. 3 is a block diagram illustrating the detailed construction of the masters illustrated in FIG. 2 according to an exemplary embodiment of the present invention. Referring to FIG. 3, the master 220 comprises a bus interface unit 221 and a scheduler 222. The master 220 of FIG. 3 may be the master I 210 or the master II 220 in the system of FIG. 2.

The bus interface unit 221 transmits and receives data by interfacing with the bus unit 240 of FIG. 2.

If the estimated standby time is transmitted through the bus interface unit 221, the scheduler 222 schedules operations using the estimated standby time. That is, if the estimated standby time is received from the bus unit 240, and if another master is using the bus, the scheduler 222 schedules operations to perform valid following operation during the estimated standby time.

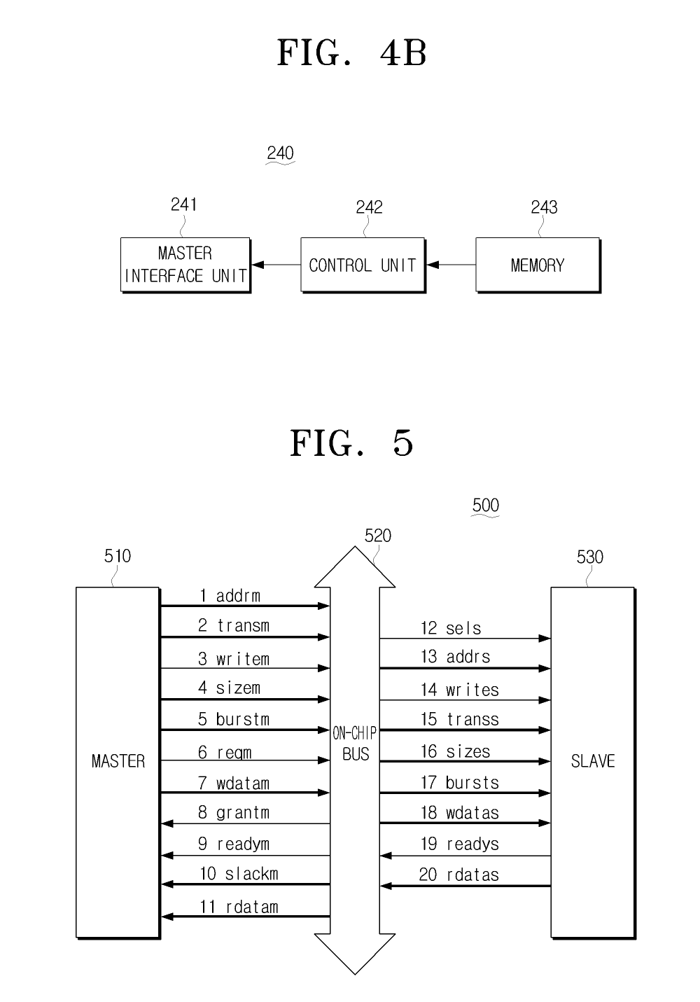

FIG. 4A is a block diagram illustrating the detailed construction of the bus unit illustrated in FIG. 2 according to an exemplary embodiment. Referring to FIG. 4A, the bus unit 240 comprises a master interface unit 241 and a control unit 242.

The master interface unit 241 communicates with the masters 210 and 220.

The control unit 242 checks the estimated standby time of the master II 220 which requests use of the bus, and transmits the checked standby time to the master II 220 through the master interface unit 241.

The estimated standby time of the master II 220 may vary according to a priority policy of the control unit 242. The priority policies of the control unit 242 may be a fixed priority scheme in which the order is absolutely fixed, a round robin priority scheme in which the priority changes in a set order, a time division multiplex (TDM) priority scheme which is a modified form of the round robin priority scheme, and a lottery scheme which adopts a concept of priority provability. That is, the control unit 212 prioritizes use of a bus, according to the frequency of bus by a master, or according to a control program.

FIG. 4B is a block diagram illustrating the detailed construction of the bus unit illustrated in FIG. 2 according to another exemplary embodiment. Referring to FIG. 4B, the bus unit 240 comprises a master interface unit 241, a control unit 242, and a memory 243. The master interface unit 241 and the control unit 242 illustrated in FIG. 4B are the same as that illustrated in FIG. 4A and thus a description thereof will be omitted.

The memory 243 stores existing standby time data of a plurality of masters. In this case, the control unit 242 may determine the estimated standby time of the respective masters considering existing standby time data stored in the memory 243.

The memory 243 stores data on the remaining time for which a master from among the plurality of masters will use a bus, and data on the time another master requests use of the bus. The control unit 242 may determine the estimated standby time of the respective masters considering the remaining time for using the bus and the requested time for using the bus stored in the memory 243.

The memory 243 stores the remaining time data for using the bus which is currently used by a master and data on the time another master requests use of the bus. The control unit 242 may determine the estimated standby time of the respective masters considering the remaining time for using the bus and the requested time for using the bus stored in the memory 243.

The memory 243 stores the fixed estimated standby time data of the respective masters. The control unit 242 may determine the estimated standby time of the respective masters considering the estimated standby time stored in the memory 243.

FIG. 5 is a diagram illustrating interface with components of an on-chip bus system according to an exemplary embodiment of the present invention.

Referring to FIG. 5, an on-chip bus system 500 comprises a master 510, an on-chip bus 520, a slave 530, and data interfaces 1 to 20.

The master 510 transmits signals of the address 1, transfer type 2, write 3, transfer size 4, burst type 5, request 6, and write data 7 to the on-chip bus 520, and receives signals of the grant 8, read 9, slack time 10, and read data 11 from the on-chip bus 520.

The on-chip bus 520 transmits signals of the selection 12, address 13, write 14, transfer type 15, transfer size 16, burst type 17, and write data 18 to the slave 530, and receives signals of ready 19, and a read data 20 from the slave 530.

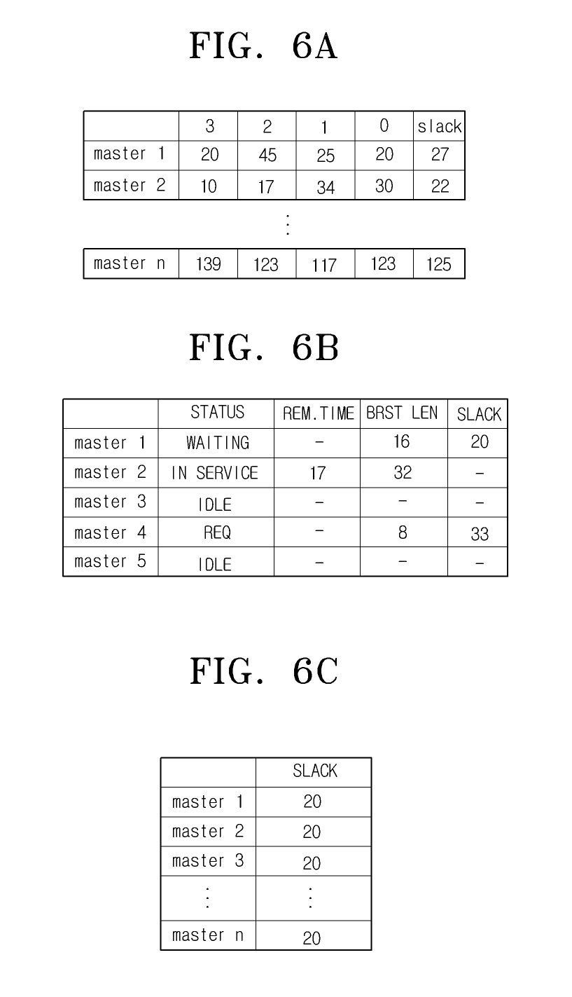

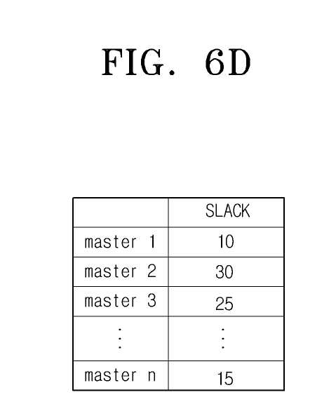

FIGS. 6A to 6D are tables illustrating various methods determining the estimated standby time of the master.

FIG. 6A is a table illustrating a method for determining the estimated standby time using the existing standby time.

In FIG. 6A, columns represent existing standby times which are allotted to the masters, and rows represent the kind of master. Referring to FIG. 6A, 20 cycles are allotted to a master 1 in the 0^{th} time, 25 cycles are allotted in a first time, 45 cycles are allotted in a second time, and 20 cycles are allotted in a third time. The bus unit 240 may determine the current estimated standby time of the master 1 by averaging the standby time which is allotted to the master 1. Although data of the existing standby time is filled to the fourth time, and units of time are expressed in seconds, this is merely an exemplary embodiment, and may be modified as occasion demands.

FIG. 6B is a table illustrating a method for determining the estimated standby time by using the status of a bus which masters currently use.

In FIG. 6B, columns represent the status of masters (STATUS), the remaining time for using a bus (REM. TIME), burst length (BRST LEN), and estimated standby time (SLACK), and rows represent the kind of master. Referring to FIG. 6B, the master 1 is in a waiting state (WAITING), the BRST LEN is 16 cycles, and SLACK is 20 cycles. The master 2 is in service (IN SERVICE), the REM. TIME is 17 cycles, and the BRST LEN is 32 cycles. Masters 3 and 5 are in idle state (IDLE), and master 4 is in a bus use request state (REQ), and the BRST LEN is 8 cycles.

Standby time is allotted to the master 4 which has requested use of a bus. The standby time is determined by adding 16 cycles of the BRST LEN of the master 1 which is in WAITING to 17 cycles of the REM. TIME of the master 1 which is IN SERVICE.

The exemplary embodiment allotting estimated standby time is described regardless of the priority order of the masters, but the estimated standby time may be modified when considering the priority order of the masters. For example, although the estimated standby time is allotted to the master 1 prior to the master 4, the estimated standby time is allotted to the master 4 so that the master previously transmits and receives data, in the case that the master 4 has a higher priority than the master 1.

FIGS. 6C and 6D are tables illustrating a case of fixing the estimated standby time for the respective masters.

FIG. 6C is a table illustrating a case of presetting the same estimated standby time for the respective masters. Referring to FIG. 6C, the same estimated standby time may be preset for the respective masters 1 to n, and the bus unit 240 transmits the estimated standby time to the masters so that the master can schedule other operations during the estimated standby time.

FIG. 6D is a table illustrating a case of presetting different estimated standby times for the respective masters. Referring to FIG. 6D, the different estimated standby time may be preset for the respective masters, and the bus unit 240 transmits the estimated standby time to the masters so that the master can schedule other operations during the transmitted estimated standby time. The estimated standby time for the respective masters may be set considering the character of the respective masters and status for using a bus.

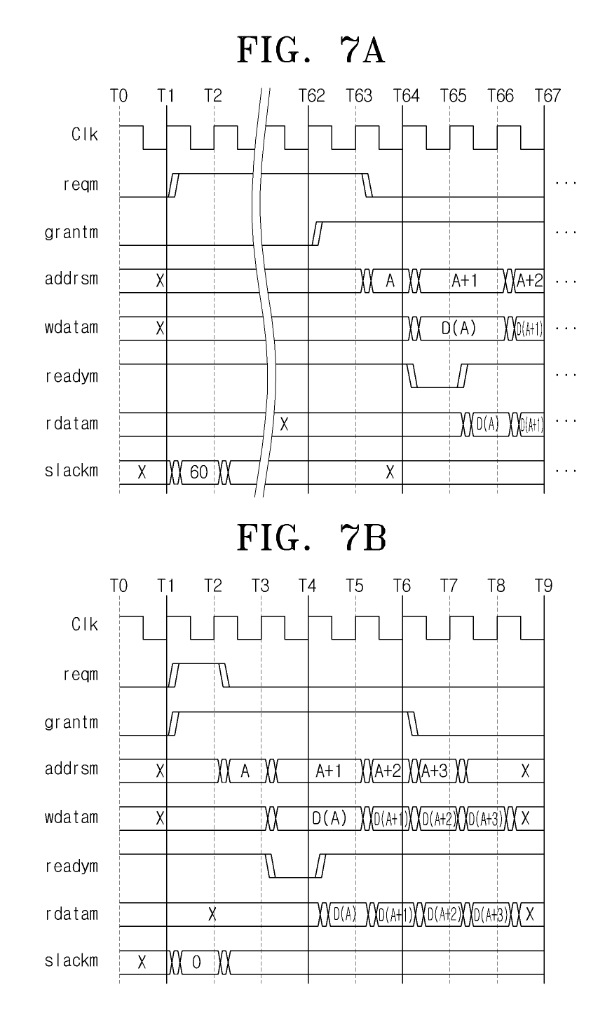

FIGS. 7A and 7B are timing diagrams illustrating the estimated standby time of the masters according to various cases.

FIG. 7A is a timing diagram illustrating a case of transmitting the estimated standby time of about 60 cycles, after a request signal (reqm) for using a bus is transmitted until a grant signal (gratm) for using a bus is transmitted.

FIG. 7B is a timing diagram illustrating a case of transmitting an estimated standby time of 0 cycle as a case in which a grant signal is immediately transmitted after a request signal is transmitted.

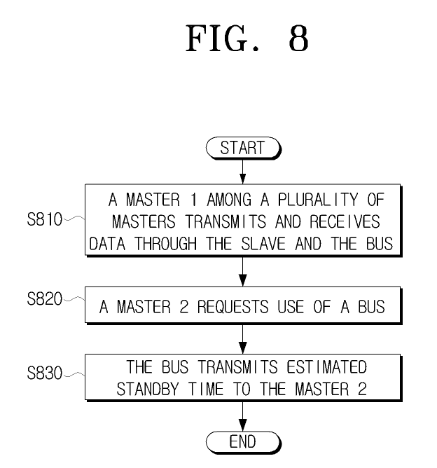

FIG. 8 is a flowchart illustrating a method for controlling a bus system according to an exemplary embodiment of the present invention. The bus system may be implemented as an on-chip bus system which is used in an SoC.

According to the control method of FIG. 8, a master 2 requests use of a bus (S820), while a master 1 among a plurality of masters transmits and receives data through the slave and the bus (S810). The bus transmits estimated standby time to the master 2 (S830).

The bus may determine the estimated standby time and transmit the estimated standby time to the master 2 considering the existing standby time of the plurality of masters.

The estimated standby time may be determined considering the remaining time for using the bus which is used by the master 1, and the requested time for using the bus of a master which requests preferential use of the bus.

The estimated standby time may be determined considering the priority order of the master 2 and the another master which requests preferential use of the bus, and the remaining time for using the bus which is used by the master 2 and the requested time for using the bus of a master which requests use of the bus.

The estimated standby time to being transmitted to the master 2 may be determined considering the estimated standby time fixed according to the plurality of masters.

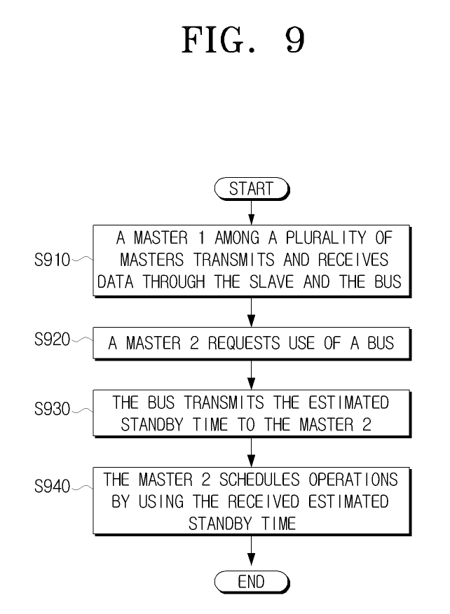

FIG. 9 is a flowchart illustrating a method for controlling a bus system according to another exemplary embodiment of the present invention.

According to a control method of FIG. 9, a master 2 requests use of a bus (S920), while a master 1 among a plurality of masters transmits and receives data through the slave and the bus (S910). The bus transmits the estimated standby time to the master 2 (S930).

The master 2 may schedule operations using the estimated standby time received from the bus (S940).

Accordingly, the master can perform a valid operation during the standby time for use of the bus.

According to the exemplary embodiments of the present invention as described above, a bus checks estimated standby time of a master, and transmits the checked estimated standby time. Accordingly, the master can perform valid operation through inside scheduling during the estimated standby time, thereby enhancing user convenience.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bus system comprising:
a plurality of masters;
a slave; and
a bus unit which supports connections between the plurality of masters and the slave via a bus, and transmits an estimated standby time to at least one master among the plurality of masters if one of the plurality of masters already occupies the bus.

2. The bus system of claim 1, wherein the bus unit comprises:
a master interface unit which communicates with the plurality of masters; and
a control unit which checks the estimated standby time, and transmits the checked standby time to the at least one master through the master interface unit.

3. The bus system of claim 2, wherein the bus unit further comprises:
a memory which stores data on an existing standby time of the plurality of masters;
wherein the control unit determines the estimated standby time based on the existing standby time.

4. The bus system of claim 2, wherein the bus unit further comprises:
a memory which stores data on a remaining time for which a master from among the plurality of masters will use the bus, and data on a requested time another master requests use of the bus;
wherein the control unit determines the estimated standby time based on the remaining time for using a bus and the requested time for using a bus.

5. The bus system of claim 1, wherein the bus unit further comprises:
a memory which stores data on a remaining time for which a master from among the plurality of masters will use the bus, and data on a requested time another master requests use of the bus;
wherein the control unit determines the estimated standby time considering the remaining time for using the bus and the requested time for using the bus.

6. The bus system of claim 2, wherein the bus unit further comprises:
a memory which stores a fixed estimated standby time data on the plurality of masters;
wherein the control unit determines the estimated standby time based on the fixed estimated standby time.

7. The bus system of claim 1, wherein the master comprises:
a bus interface unit which transmits and receives data by interfacing with the bus unit; and
a scheduler which schedules operations using the estimated standby time if the estimated standby time is transmitted through the bus interface unit.

8. The bus system of claim 1, wherein the bus system is an on chip bus system which is used in a System-on-Chip (SoC).

9. A method of controlling a bus system comprising a bus unit which supports connections between a plurality of masters and a slave via a bus, the method comprising:
transmitting and receiving data through the slave and the bus by a first master of the plurality of masters;
requesting a use of the bus by a second master; and
transmitting estimated standby time of the second master.

10. The method of claim 9, further comprising:
determining the estimated standby time based on an existing standby time of the plurality of masters.

11. The method of claim 9, further comprising:
determining the estimated standby time based on the remaining time for using the bus of the second master and a requested time of another master which previously requests use of the bus.

12. The method of claim 9, further comprising:
determining a priority order of masters which requests use of the bus; and
determining the estimated standby time based on a remaining time for using a bus of the first master and a requested time for using a bus of another master if there is another master having a higher priority than the second master.

13. The method of claim 9, further comprising:
determining the estimated standby time based on fixed estimated standby time data on the plurality of masters.

14. The method of claim 9, further comprising:
scheduling operations using the estimated standby time which is received from the bus.

15. The method of claim 9, wherein the bus system is an on chip bus system which is used in a System-on-Chip (SoC).
